(19) United States
(12) Patent Application Publication
(10) Pub. No.: US 2026/0039741 A1
(43) Pub. Date: Feb. 5, 2026

(54) ELECTRONIC APPARATUS, USER TERMINAL FOR PREVENTING CROSS-CONNECTION AND OPTIMIZING LATENCY AND CONTROL METHODS THEREOF

(71) Applicant: Samsung Electronics Co., Ltd., Suwon-si (KR)

(72) Inventors: Sangwook LEE, Suwon-si (KR); Ikchae Jeong, Suwon-si (KR)

(73) Assignee: SAMSUNG ELECTRONICS CO., LTD., Suwon-si (KR)

(21) Appl. No.: 19/239,453

(22) Filed: Jun. 16, 2025

Related U.S. Application Data
(63) Continuation of application No. PCT/KR2025/006168, filed on May 8, 2025.

(30) Foreign Application Priority Data
Aug. 2, 2024 (KR) 10-2024-0103399

(51) Int. Cl. H04M 1/72412; G06F 3/16; H04R 1/10; H04R 3/04

(52) U.S. Cl. CPC H04M 1/72412; G06F 3/162; H04R 1/1041; H04R 3/04; H04R 2420/07

(57) ABSTRACT

According to an aspect of the present disclosure, an electronic apparatus includes one or more processors and memory storing instructions. The instructions, when executed by the one or more processors individually or collectively, cause the electronic apparatus to transmit, to a first user terminal, first equalizer information of the electronic apparatus, receive, from the first user terminal, first time information, transmit, to the first user terminal, a first wear state of a user of the electronic apparatus, based on the first wear state, based on a first activation signal being received from the first user terminal, output a first sound, based on a second sound being received, obtain second equalizer information and second time information corresponding to the second sound, and establish a communication channel with the first user terminal based on the first equalizer information, the second equalizer information, the first time information, and the second time information.

### CROSS-REFERENCE TO RELATED APPLICATIONS

This application is a continuation application of International Application No. PCT/KR2025/006168, filed on May 8, 2025, which claims priority to Korean Patent Application No. 10-2024-0103399, filed on Aug. 2, 2024, in the Korean Intellectual Property Office, the disclosures of which are incorporated by reference herein in their entireties.

### BACKGROUND

### 1. Field

The present disclosure relates to an electronic apparatus, a user terminal, and control methods thereof, and more particularly, to an electronic apparatus and user terminal for preventing cross-connection and optimizing latency, and control methods thereof.

### 2. Description of Related Art

Various types of electronic apparatuses may be being developed due to development in electronic technologies. For example, attempts to improve user convenience related to the use of wireless earphones may be pursued.

Wireless earphones may include a speaker which is inserted in the ears of a person and provide sounds such as music, voices, or the like. The wireless earphones may utilize a time-delay that may be defined in a standard telecommunications protocol (e.g., Bluetooth™) and may sense a cross-connection during use.

The time-delay may be set, for example, to values that may range from several milliseconds (ms) to several hundred milliseconds, and may be used to support the prevention of cross-connection in a multi-device environment. However, performance of the wireless earphones in an actual-use environment may be of an unsatisfactory level.

For example, even when a standard method is used, a user may experience intermittently generated phenomena when performing common operations such as, but not limited to, initializing coupling with the wireless earphones. Thus, there exists a need for further improvements in wireless earphone technology, as the need for a satisfactory user experience may be constrained by an inconvenient use environment and/or latency. Improvements are presented herein. These improvements may also be applicable to other telecommunications technologies and the telecommunications standards that employ these technologies.

### SUMMARY

One or more example embodiments of the present disclosure provide an electronic apparatus and a user terminal for preventing cross-connection and optimizing latency, and control methods thereof.

According to an aspect of the present disclosure, an electronic apparatus includes a communication interface, a speaker, a microphone, one or more processors including processing circuitry, and memory storing instructions. The instructions, when executed by the one or more processors individually or collectively, cause the electronic apparatus to transmit, to a first user terminal through the communication interface, first equalizer information of the electronic apparatus, receive, from the first user terminal through the communication interface, first time information, transmit, to the first user terminal through the communication interface, a first wear state of a user of the electronic apparatus, based on the first wear state, based on a first activation signal being received from the first user terminal through the communication interface, output a first sound via the speaker, based on a second sound being received through the microphone, obtain second equalizer information and second time information corresponding to the second sound, and establish, through the communication interface, a communication channel with the first user terminal based on the first equalizer information, the second equalizer information, the first time information, and the second time information.

The instructions, when executed by the one or more processors individually or collectively, may further cause the electronic apparatus to, based on the first equalizer information and the second equalizer information being the same, and the first time information and the second time information being the same, establish the communication channel with the first user terminal through the communication interface.

The instructions, when executed by the one or more processors individually or collectively, may further cause the electronic apparatus to, based on the first equalizer information and the second equalizer information being the same, and the first time information and the second time information being the same, identify a second wear state of the user of the electronic apparatus, and establish, through the communication interface, the communication channel with the first user terminal based on the second wear state.

The instructions, when executed by the one or more processors individually or collectively, may further cause the electronic apparatus to, based on a difference between the second wear state and the first wear state being less than a predetermined difference, establish the communication channel with the first user terminal through the communication interface.

The instructions, when executed by the one or more processors individually or collectively, may further cause the electronic apparatus to, based on the electronic apparatus being identified as worn by the user, transmit the first wear state to the first user terminal through the communication interface.

The electronic apparatus may further include a sensor. The instructions, when executed by the one or more processors individually or collectively, may further cause the electronic apparatus to obtain the first wear state using the sensor.

The instructions, when executed by the one or more processors individually or collectively, may further cause the electronic apparatus to obtain the first wear state based on transfer functions of first signal information corresponding to the first sound and second signal information corresponding to the second sound.

The first activation signal may include a command to output a third sound for a time duration based on the second time information at a level based on the second equalizer information.

The instructions, when executed by the one or more processors individually or collectively, may further cause the electronic apparatus to transmit, to a second user terminal through the communication interface, the first equalizer information, receive, from the second user terminal through the communication interface, third time information, transmit, to the second user terminal through the communication interface, the first wear state, and based on an earlier received signal from among the first activation signal being received from the first user terminal and a second activation signal being received from the second user terminal through the communication interface, output a third sound via the speaker.

According to an aspect of the present disclosure, a user terminal includes a communication interface, one or more processors including processing circuitry, and memory storing instructions. The instructions, when executed by the one or more processors individually or collectively, cause the user terminal to receive, from a first electronic apparatus through the communication interface, first equalizer information of the first electronic apparatus, transmit, to the first electronic apparatus through the communication interface, first time information, based on a wear state being received from the first electronic apparatus through the communication interface, transmit a first activation signal to the first electronic apparatus through the communication interface based on the first equalizer information corresponding to the first electronic apparatus and the first time information, and establish, through the communication interface, a communication channel with the first electronic apparatus based on a request of the first electronic apparatus.

The instructions, when executed by the one or more processors individually or collectively, may further cause the user terminal to receive, from a second electronic apparatus through the communication interface, second equalizer information of the second electronic apparatus, transmit, to the second electronic apparatus through the communication interface, the first time information, identify a device corresponding to an earlier received wear state from among a first wear state received from the first electronic apparatus and a second wear state received from the second electronic apparatus through the communication interface, and transmit a second activation signal to the first electronic apparatus and the second electronic apparatus, based on equalizer information corresponding to the device and time information.

According to an aspect of the present disclosure, a control method of an electronic apparatus includes transmitting, to a first user terminal, first equalizer information of the electronic apparatus, receiving, from the first user terminal, first time information, transmitting, to the first user terminal, a first wear state of a user of the electronic apparatus, based on a first activation signal being received from the first user terminal, outputting a first sound via a speaker of the electronic apparatus, based on a second sound being received through a microphone of the electronic apparatus, obtaining second equalizer information corresponding to the second sound and second time information, and establishing a communication channel with the first user terminal based on the first equalizer information, the second equalizer information, the first time information, and the second time information.

The establishing of the communication channel may include, based on the first equalizer information and the second equalizer information being the same, and the first time information and the second time information being the same, establishing the communication channel with the first user terminal.

The establishing of the communication channel may include, based on the first equalizer information and the second equalizer information being the same, and the first time information and the second time information being the same, identifying a second wear state of the user of the electronic apparatus, and establishing the communication channel with the first user terminal based on the second wear state.

The establishing of the communication channel may include, based on a difference between the second wear state and the first wear state being less than a predetermined difference, establishing the communication channel with the first user terminal.

The transmitting of the first wear state may include, based on the electronic apparatus being identified as worn by the user, transmitting the first wear state to the first user terminal.

The control method may further include obtaining, using a sensor of the electronic apparatus, the first wear state.

The control method may further include obtaining the first wear state based on transfer functions of first signal information corresponding to the first sound and second signal information corresponding to the second sound.

The first activation signal may include a command to output a third sound for a time duration based on the second time information at a level based on the second equalizer information.

The control method may further include transmitting, to a second user terminal, the first equalizer information, receiving, from the second user terminal, third time information, transmitting, to the second user terminal, the first wear state, outputting, via the speaker, a third sound based on an earlier received signal from among the first activation signal being received from the first user terminal and a second activation signal being received from the second user terminal.

Additional aspects may be set forth in part in the description that follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram illustrating a wireless communication connection, according

to an embodiment of the disclosure;

FIG. 2 is a block diagram illustrating a configuration of an electronic system, according to an embodiment of the disclosure;

FIG. 3 is a block diagram illustrating a configuration of an electronic apparatus, according to an embodiment of the disclosure;

FIG. 4 is a block diagram illustrating a detailed configuration of an electronic apparatus, according to an embodiment of the disclosure;

FIG. 5 is a block diagram illustrating a configuration of a user terminal, according to an embodiment of the disclosure;

FIGS. 6 and 7 are diagrams illustrating an operation in a communication connection period, according to an embodiment of the disclosure;

FIGS. 8 and 9 are diagrams illustrating an operation with a plurality of transmitting apparatuses, according to an embodiment of the disclosure;

FIGS. 10 and 11 are diagrams illustrating an operation with a plurality of receiving apparatuses, according to an embodiment of the disclosure;

FIGS. 12 and 13 are diagrams illustrating an operation with a plurality of transmitting apparatuses and a plurality of receiving apparatuses, according to an embodiment of the disclosure;

FIGS. 14 and 15 are diagrams illustrating an operation when a transmitting apparatus from among a plurality of transmitting apparatuses moves, according to an embodiment of the disclosure;

FIG. 16 is a flowchart illustrating a control method of an electronic apparatus, according to an embodiment of the disclosure; and

FIG. 17 is a flowchart illustrating a control method of a user terminal, according to an embodiment of the disclosure.

### DETAILED DESCRIPTION

The exemplary embodiments of the present disclosure may be diversely modified. Accordingly, specific exemplary embodiments are illustrated in the drawings and are described in the detailed description. However, it is to be understood that the present disclosure may not be limited to a specific exemplary embodiment, but may include all modifications, equivalents, and substitutions without departing from the scope and spirit of the present disclosure. Also, well-known functions and/or constructions may not described in detail to avoid potentially obscuring the present disclosure with unnecessary detail.

Terms used in describing an embodiment of the disclosure may be general terms selected that may be currently widely used considering their function herein. However, the terms may change depending on intention, legal or technical interpretation, emergence of new technologies, or the like of those skilled in the related art. Further, in some cases, there may be terms arbitrarily selected, and in such cases, the meaning of the term may be disclosed in the relevant description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the relevant element.

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

In the disclosure, the term “user” may refer to a person using an electronic apparatus or an apparatus (e.g., artificial intelligence (AI) electronic apparatus) using the electronic apparatus.

With regard to the description of the drawings, similar reference numerals may be used to refer to similar or related elements. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanied drawings.

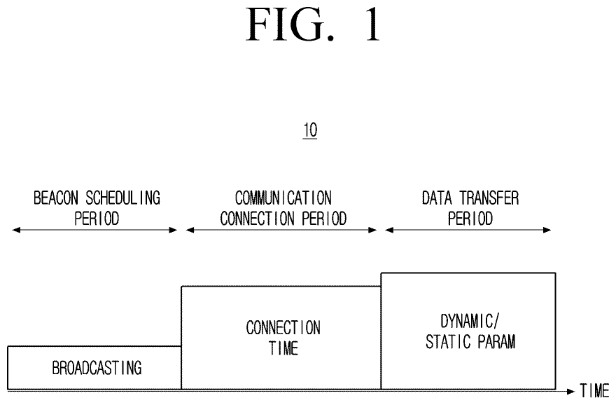

FIG. 1 is a diagram illustrating a wireless communication connection, according to an embodiment of the disclosure.

A wireless communication connection process 10 may include, as shown in FIG. 1, forming (establishing) a communication channel through a beacon scheduling period and a communication connection period, and data desired by a user for transmission to be transmitted during a data transfer period when the communication channel is formed.

For example, an electronic apparatus (e.g., wireless earphones) may broadcast an advertising packet that may include wireless communication connection request information, such as, but not limited to, Bluetooth communication connection request information. For example, the wireless communication connection request information may include information on a signal requesting communication connection for the electronic apparatus to transmit and/or receive data with a user terminal (e.g., a smartphone) using a predetermined wireless communication technology (e.g., Bluetooth™).

The advertising packet may be and/or may include a transmitted signal that may be targeted to random (unidentified) devices rather than a signal transmitted targeting a specific (identified) device. For example, the advertising packet may be and/or may include a packet of a Bluetooth Low Energy (BLE) type. BLE may refer to a Bluetooth™ technology capable of transmitting and/or receiving low-energy and/or low-capacity data in a 2.4 GHz frequency band having a reach radius of approximately 10 meters (m).

The advertising packet may include the Bluetooth communication connection request information corresponding to a user command for a Bluetooth communication connection. That is, the advertising packet may include the Bluetooth communication connection request information generated based on a user command (or input). Accordingly, the user terminal that received the advertising packet included with the Bluetooth communication connection request information corresponding to the user command may identify that the communication connection request information is a communication connection request information, according to the user command.

The electronic apparatus and the user terminal may exchange information on each device during the communication connection period and information for forming a communication channel, and may form the communication channel. The user terminal may transmit, when the communication channel is formed with the electronic apparatus, sound data to the electronic apparatus, and the electronic apparatus may output the sound data received from the user terminal.

In some embodiments, when information exchange is completed, the communication connection period may be maintained for a pre-set time. For example, the communication connection period may be set to 500 milliseconds (ms). That is, the communication connection may be maintained until the communication connection period has expired, which may contribute to increasing latency.

In addition, if another apparatus intervenes during the connection process described above, a communication channel that may not be intended by the user may be formed. For example, if another electronic apparatus broadcasts an advertising packet just before the electronic apparatus broadcasts the advertising packet, the user terminal may form a communication channel with the other electronic apparatus rather than the electronic apparatus. As a result, the communication channel may not be formed as intended by the user.

Accordingly, there is a need for preventing formation of unintended communication channels, as well as, addressing increases in latency.

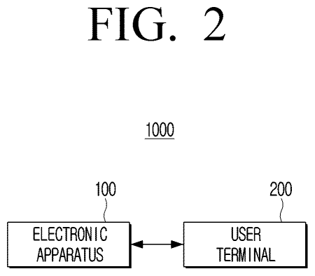

FIG. 2 is a block diagram illustrating a configuration of an electronic system 1000, according to an embodiment of the disclosure. Referring to FIG. 2, the electronic system 1000 may include an electronic apparatus 100 and a user terminal 200.

The electronic apparatus 100 may be and/or may include an apparatus that may form a communication channel with the user terminal 200. For example, the electronic apparatus 100 may be and/or may include an apparatus that may form the communication channel with the user terminal 200 such as, for example, and without limitation, wireless earphones, a wireless speaker, smart glasses, a smart watch, or the like, according to a Bluetooth™ communication standard. However, embodiments of the present disclosure are not limited thereto, and the electronic apparatus 100 may be any apparatus capable of forming a communication channel with the user terminal 200.

The electronic apparatus 100 may broadcast the advertising packet, and after performing an operation for preventing cross-connection with the user terminal 200 for the communication connection period, form the communication channel. The electronic apparatus 100 may form, when an operation for preventing cross-connection is completed, the communication channel without maintaining the communication connection period for a pre-set time, which may reduce latency.

The user terminal 200 may be and/or may include a device that may form the communication channel with the electronic apparatus 100. For example, the user terminal 200 may be and/or may include a device that may form the communication channel with the electronic apparatus 100 such as, for example, and without limitation, a desktop personal computer (PC), a television (TV), a notebook, a smartphone, a tablet PC, or the like, according to the Bluetooth™ communication standard. However, embodiments of the present disclosure are not limited thereto, and the user terminal 200 may be any device so long as it is a device that forms the communication channel with the electronic apparatus 100.

The user terminal 200 may form, based on the advertising packet being received from the electronic apparatus 100, the communication channel after performing the operation for preventing cross-connection with the electronic apparatus 100 for the communication connection period. The user terminal 200 may form, when the operation for preventing cross-connection is completed, the communication channel without maintaining the communication connection period for a pre-set time, which may reduce latency.

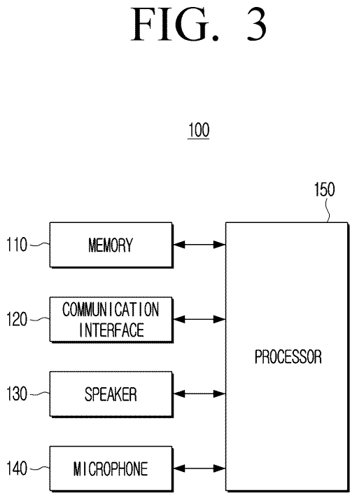

The operation for preventing cross-connection is described with reference to FIG. 3.

FIG. 3 is a block diagram illustrating a configuration of the electronic apparatus 100, according to an embodiment of the disclosure.

Referring to FIG. 3, the electronic apparatus 100 may include a memory 110, a communication interface 120, a speaker 130, a microphone 140, and a processor 150. However, embodiments are not limited thereto, and the electronic apparatus 100 may be implemented with a portion of the configurations excluded.

The memory 110 may refer to hardware that may store information such as, but not limited to, data in electric and/or magnetic form for the processor 150 or the like to access. For example, the memory 110 may be implemented as at least one from among a non-volatile memory, a volatile memory, a flash memory, a hard disk drive (HDD), a solid state drive (SSD), a random access memory (RAM), a read only memory (ROM), or the like.

The memory 110 may store at least one instruction that may be needed in an operation of the electronic apparatus 100 and/or the processor 150. The instruction may refer to a code unit that may instruct (cause) an operation of the electronic apparatus 100 and/or the processor 150, and may be prepared in a machine language that may be understood (interpreted and/or executed) by a computer.

The memory 110 may store data that may be information formatted in a bit and/or byte unit that may represent a character, a number, an image, or the like. For example, the memory 110 may store one or more instructions for controlling the electronic apparatus 100.

The memory 110 may be accessed by the processor 150, which may perform reading, writing, modifying, deleting, updating, or the like of the instructions, the instruction set, and/or the data stored in the memory 110.

The communication interface 120 may be configured to perform communication with external devices of various types according to communication methods of various types. For example, the electronic apparatus 100 may perform communication with the user terminal 200 and/or an external device through the communication interface 120.

The communication interface 120 may be and/or may include, but not be limited to, a Wireless Fidelity (Wi-Fi) module, a Bluetooth module, an infrared communication module, a wireless communication module, or the like. Each communication module of the communication interface 120 may be implemented in at least one hardware chip form.

The Wi-Fi module and the Bluetooth module may perform communication in a Wi-Fi method and a Bluetooth method, respectively. When using the Wi-Fi module and/or the Bluetooth module, various connection information such as, but not limited to, a service set identifier (SSID) and a session key, may be transmitted and received, and after performing communication connection using the same, various information may be transmitted and received. The infrared communication module may perform communication according to an infrared communication technology (e.g., Infrared Data Association (IrDA)) of transmitting data wirelessly in short range by using infrared rays present between visible rays and millimeter waves.

The wireless communication module may include at least one communication chip that may perform communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), or the like, in addition to the above-described communication methods.

Alternatively, the communication interface 120 may include a wired communication interface such as, for example, and without limitation, high-definition multimedia interface (HDMI), DisplayPort (DP), Thunderbolt, universal serial bus (USB), Red, Green, Blue (RGB), d-subminiature (D-SUB), digital visual interface (DVI), or the like.

In addition, the communication interface 120 may include at least one from among wired communication modules that may perform communication using a local area network (LAN) module, an Ethernet module, or a pair cable, a coaxial cable, an optical fiber cable, or the like.

The speaker 130 may be and/or may include an element that may output various audio data processed in the processor 150, as well as, various notification sounds, voice messages, or the like.

The microphone 140 may be configured to receive sound and convert the sound to an audio signal. The microphone 140 may be electrically connected with the processor 150, and may receive sound by control of the processor 150.

For example, the microphone 140 may be formed as an integrated-type integrated to an upper side or a front surface direction, a side surface direction or the like of the electronic apparatus 100. Alternatively, the microphone 140 may be provided in a remote controller, or the like separate from the electronic apparatus 100. In this case, the remote controller may receive sound through the microphone 140, and provide the received sound to the electronic apparatus 100.

The microphone 140 may include various configurations such as, but not limited to, a microphone that may collect sound in an analog form, an amplifier circuit that may amplify the collected sound, an analog/digital (A/D) converter circuit that may sample the amplified sound and may convert to a digital signal, a filter circuit that may remove noise components from the converted digital signal, or the like.

The microphone 140 may be implemented in a form of a sound sensor, and may be and/or may include any method capable of collecting sound.

The processor 150 may control an overall operation of the electronic apparatus 100. That is, the processor 150 may control the overall operation of the electronic apparatus 100 by being connected with each configuration (element) of the electronic apparatus 100. For example, the processor 150 may control an operation of the electronic apparatus 100 by being connected with configurations such as, but not limited to, the memory 110, the communication interface 120, the speaker 130, and the microphone 140.

The processor 150 may be implemented as one or more processors. The one or more processors may include one or more from among, but not limited to, a central processing unit (CPU), a graphics processing unit (GPU), an accelerated processing unit (APU), a many integrated core (MIC), a digital signal processor (DSP), a neural processing unit (NPU), a hardware accelerator, a machine learning accelerator, or the like. The one or more processors may control one or a random combination from among other elements of the electronic apparatus 100, and may perform an operation associated with communication or data processing. The one or more processors may execute, individually or collectively, one or more programs or instructions stored in the memory 110. For example, the one or more processors may perform, by executing the one or more instructions stored in the memory 110, a method according to an embodiment of the disclosure.

When a method, according to an embodiment of the disclosure, includes a plurality of operations, the plurality of operations may be performed by one processor, or performed by a plurality of processors. For example, when a first operation, a second operation, and a third operation are performed by a method, according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence (AI) dedicated processor). For example, a process for quantizing a neural network model, according to an embodiment of the disclosure may be performed by the generic-purpose processor, and a process for training or inferring the quantized neural network model may be performed by the AI dedicated processor.

The one or more processors may be implemented as a single core processor that may include one core, or implemented as one or more multicore processors that may include a plurality of cores (e.g., a homogeneous multicore or a heterogeneous multicore). If the one or more processors are implemented as multicore processors, each of the plurality of cores included in the multicore processors may include a memory inside the processor such as, but not limited to, a cache memory and an on-chip memory, and/or a common cache shared by the plurality of cores may be included in the multicore processors. In addition, each of the plurality of cores (or a portion from among the plurality of cores) included in the multicore processors may independently read and perform a program command for implementing a method, according to an embodiment of the disclosure, and/or read and perform a program command for implementing a method, according to an embodiment of the disclosure, due to a whole (or a portion) of the plurality of cores being interconnected.

When a method, according to an embodiment of the disclosure, includes a plurality of operations, the plurality of operations may be performed by one core from among the plurality of cores or performed by the plurality of cores included in the multicore processors. For example, when a first operation, a second operation, and a third operation are performed by a method, according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In some embodiments of the disclosure, the one or more processors may refer to a system on chip (SoC), the single core processor, or the multicore processors in which the one or more processors and other electronic components are integrated or a core included in the single core processor or the multicore processors, and the core herein may be implemented as the CPU, the GPU, the APU, the MIC, the DSP, the NPU, the hardware accelerator, the machine learning accelerator, or the like. However, embodiments of the present disclosure are not limited thereto. However, for convenience of description, an operation of the electronic apparatus 100 is described below using the expression ‘processor 150.’

The processor 150 may broadcast the advertising packet when a user command for forming the communication channel with the user terminal 200 is received. For example, the processor 150 may broadcast the advertising packet when a user command for turning on a Bluetooth function is received.

The processor 150 may exchange, based on a response to the advertising packet of the user terminal 200, information on each device during the communication connection period and information for forming the communication channel, and form the communication channel.

The processor 150 may control the communication interface 120 to transmit first equalizer information of the electronic apparatus 100 to the user terminal 200 during the communication connection period, and receive first time information from the user terminal 200 through the communication interface 120.

The first equalizer information may include information on intensity of sound set in the electronic apparatus 100. However, embodiments of the present disclosure are not limited thereto, and the processor 150 may control the communication interface 120 to transmit information associated with sound output from the electronic apparatus 100 such as, filter processing information rather than the first equalizer information, to the user terminal 200.

The first time information may be time information randomly set by the user terminal 200. For example, the first time information may be one from among 1 ms, 2 ms, 4 ms, 6 ms, 8 ms, and 10 ms. However, embodiments of the present disclosure are not limited thereto, and the first time information may be set in any various means. In addition, the first time information may include a plurality of time periods. For example, the first time information may include 1 ms and 3 ms.

The processor 150 may identify, after transmission and receipt of the first equalizer information and the first time information, a wear state of the user of the electronic apparatus 100.

The processor 150 may control the communication interface 120 to transmit the wear state to the user terminal 200 based on the wear state of the user of the electronic apparatus 100. For example, the processor 150 may control, based on the electronic apparatus 100 being identified as worn by the user, the communication interface 120 to transmit the wear state to the user terminal 200, and not perform any operation based on the electronic apparatus 100 being identified as not worn by the user.

The processor 150 may obtain the wear state through a sensor, and/or obtain the wear state based on transfer functions of first signal information corresponding to sound output through the speaker 130 and second signal information corresponding to sound received through the microphone 140. For example, the sensor may include a vibration detection sensor, and the processor 150 may identify the wear state based on vibrations by the user. Alternatively or additionally, the processor 150 may identify, based on the electronic apparatus 100 being worn by the user, the wear state by comparing sound being output to an external auditory canal through the speaker 130 with sound within the external auditory canal obtained through the microphone 140.

However, embodiments of the present disclosure are not limited thereto, and the processor 150 may identify the wear state through any various means.

The processor 150 may control, based on an activation signal being received from the user terminal 200 through the communication interface 120, the speaker 130 to output sound based on the activation signal, and obtain, based on sound being received through the microphone 140, second equalizer information and second time information corresponding to the sound. For example, the activation signal may include a command to output sound for a time based on the second time information at a level based on the second equalizer information. In an example, the processor 150 may output sound for 1 ms at a first level based on an activation signal. Alternatively or additionally, the processor 150 may output sound for 1 ms at a second level that may be greater than the first level, not output sound for 1 ms, and output sound for 3 ms based on the activation signal.

As used herein, the activation signal may refer to a signal generated based on the equalizer information and the time information corresponding to the apparatus that provided wear information according to the user terminal 200 having received the wear information. For example, the equalizer information may be and/or may include information that an apparatus that provided the wear information provided to the user terminal 200, and the time information may be and/or may include information that the user terminal 200 provided to the apparatus that provided the wear information. If the apparatus that provided the wear information is the electronic apparatus 100, the user terminal 200 may provide an activation signal based on the first equalizer information and the first time information to the electronic apparatus 100. Alternatively or additionally, if the apparatus that provided the wear information is another electronic apparatus, the user terminal 200 may provide an activation signal based on third equalizer information and third time information to the electronic apparatus 100 and the other electronic apparatus. The third time information may be and/or may include time information randomly set by another user terminal.

That is, the processor 150 may receive an activation signal generated according to wearing of the electronic apparatus 100 from the user terminal 200, and/or receive an activation signal generated according to wearing of the other electronic apparatus from the user terminal 200.

Although the second equalizer information and the second time information has been described in association with the activation signal for convenience of description, the activation signal may be generated according to the wearing of the electronic apparatus 100, and/or may be generated according to the wearing of the other electronic apparatus. That is, the second equalizer information and the second time information described above may be the same as or different from the first equalizer information and the first time information, respectively.

The processor 150 may control the communication interface 120 to form the communication with the user terminal 200 based on the first equalizer information, the second equalizer information, the first time information, and the second time information.

For example, the processor 150 may control, based on the first equalizer information and the second equalizer information being the same, and the first time information and the second time information being the same, the communication interface 120 to form the communication channel with the user terminal 200.

Alternatively, the processor 150 may re-identify, based on the first equalizer information and the second equalizer information being the same, and the first time information and the second time information being the same, a wear state of the user of the electronic apparatus 100, and control the communication interface 120 to form the communication channel with the user terminal 200 based on the re-identified wear state.

For example, the processor 150 may control, based on a difference of the re-identified wear state with the wear state being less than a pre-set difference, the communication interface 120 to form the communication channel with the user terminal 200. In an example, the processor 150 may control, based on the difference of the re-identified wear state with the wear state being less than the pre-set difference, the communication interface 120 to transmit a signal for forming the communication channel to the user terminal 200.

Through the operations described above, cross-connection may be prevented. For example, an environment may be assumed in which the electronic apparatus 100, the user terminal 200, and the other user terminal are present. In addition, it may be assumed that the electronic apparatus 100 is (physically) closer to the user terminal 200 than the other user terminal, and that the user desires for the electronic apparatus 100 to be connected to the user terminal 200.

The processor 150 may broadcast the advertising packet based on the user command for forming the communication channel with the user terminal 200 being received. Because the advertising packet is not a signal transmitted targeting a specific device, the advertising packet may be provided to the user terminal 200 and to the other user terminal.

The processor 150 may control the communication interface 120 to transmit the first equalizer information of the electronic apparatus 100 to the user terminal 200, receive the first time information from the user terminal 200 through the communication interface 120, control the communication interface 120 to transmit the first equalizer information of the electronic apparatus 100 to the other user terminal, and receive the third time information from the other user terminal through the communication interface 120.

The processor 150 may control the communication interface 120 to transmit the wear state to the user terminal 200 and the other user terminal based on the wear state of the user of the electronic apparatus 100.

The processor 150 may control, based on the activation signal being received from the user terminal 200 and another activation signal being received from the other user terminal through the communication interface 120, the speaker 130 to output sound based on the signal received first (earlier) from among the activation signal and the other activation signal.

Because the user terminal 200 may be closer to the electronic apparatus 100 than the other user terminal, the processor 150 may receive the activation signal first than the other activation signal.

The processor 150 may control the speaker 130 to output sound based on the activation signal, obtain, based on sound being received through the microphone 140, the second equalizer information and the second time information corresponding to the sound, re-identify, based on the first equalizer information and the second equalizer information being the same, and the first time information and the second time information being the same, a wear state of the user of the electronic apparatus 100, and control the communication interface 120 to form the communication channel with the user terminal 200 based on the re-identified wear state.

That is, the processor 150 may prevent cross-connection because the communication channel is formed based on the activation signal received from the device more closer to the electronic apparatus 100 even if a plurality of devices are present.

In addition, because the processor 150 obtains the second equalizer information and the second time information corresponding to the sound received through the microphone 140, and forms the communication channel when the first equalizer information and the second equalizer information are the same, and the first time information and the second time information are the same, or obtains the second equalizer information and the second time information corresponding to the sound received through the microphone 140, and re-identifies a wear state of the user of the electronic apparatus 100 when the first equalizer information and the second equalizer information are the same, and the first time information and the second time information are the same, and forms the communication channel based on the re-identified wear state, latency may be reduced. That is, the processor 150 may reduce latency by forming the communication channel without maintaining the communication connection period for a pre-set time.

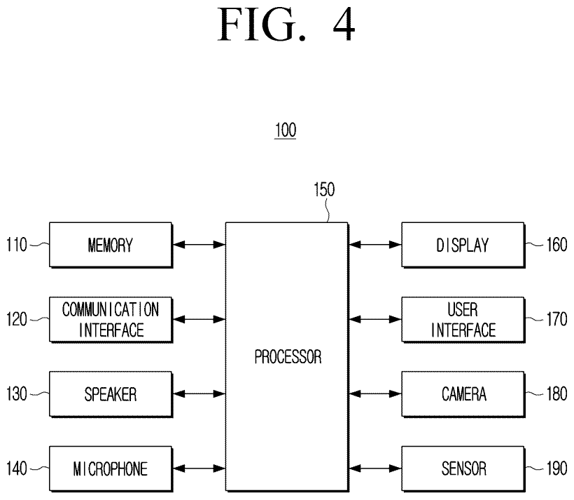

FIG. 4 is a block diagram illustrating a detailed configuration of the electronic apparatus 100, according to an embodiment of the disclosure. The electronic apparatus 100 of FIG. 4 may include and/or may be similar in many respects to the electronic apparatus 100 described above with reference to FIG. 3, and may include additional features not mentioned above. Consequently, repeated descriptions of the electronic apparatus 100 described above with reference to FIG. 3 may be omitted for the sake of brevity.

The electronic apparatus 100 may include the memory 110, the communication interface 120, the speaker 130, the microphone 140, and the processor 150. In addition, referring to FIG. 4, the electronic apparatus 100 may further include a display 160, a user interface 170, a camera 180, and a sensor 190.

The display 160 may be configured to output an image, and may be implemented as a display of various forms such as, for example, and without limitation, a liquid crystal display (LCD), an organic light emitting diode (OLED) display, a light emitting diode (LED), a micro LED, a plasma display panel (PDP), or the like. In the display 160, a driving circuit, which may be implemented in a form of an amorphous silicon thin film transistor (a-si TFT), a low temperature poly silicon (LTPS) TFT, an organic TFT (OTFT), or the like, a backlight unit, or the like may be included together therewith. Alternatively or additionally, the display 160 may be implemented as a touch screen coupled with a touch sensor, a flexible display, a three-dimensional display (3D display), or the like.

The user interface 170 may be implemented as a button, a touch pad, a mouse, a keyboard, or the like, or implemented as a touch screen capable of performing a display function and an operation input function together therewith. The button may be and/or may include buttons of various types such as, but not limited to, a mechanical button, a touch pad, or a wheel that may be formed at a random area at a front surface part or a side surface part, a rear surface part, or the like of an exterior of a main body of the electronic apparatus 100.

The camera 180 may be configured to capture a still image and/or a moving image. The camera 180 may capture a still image at a specific time-point, but may also capture one or more still images consecutively.

The camera 180 may capture an actual environment at a front direction of the electronic apparatus 100 by capturing the front direction of the electronic apparatus 100. The processor 150 may identify an area of interest from the image captured through the camera 180.

The camera 180 may include a lens, a shutter, an aperture, a solid-state imaging device, an analog front end (AFE), and a timing generator (TG). The shutter may adjust a time during which light reflected from a subject enters the camera 180, and the aperture may adjust an amount of light incident to the lens by mechanically increasing or decreasing a size of an opening part through which light enters. The solid-state imaging device may output, based on light reflected from the subject being accumulated as photo charge, an image by the photo charge as an electric signal. The TG may output a timing signal for reading out pixel data of the solid-state imaging device, and the AFE may digitalize the electric signal output from the solid-state imaging device by sampling.

The sensor 190 may be and/or may include a sensor for detecting the wearing state of the user of the electronic apparatus 100. For example, the sensor 190 may include the vibration detection sensor, and may sense the wearing state of the user of the electronic apparatus 100 based on a pulse of the user. Alternatively or additionally, the sensor 190 may include a temperature sensor, and may sense the wearing state of the user of the electronic apparatus 100 based on the temperature of the user.

However, embodiments of the present disclosure are not limited thereto, and the sensor 190 may be any configuration capable of detecting the wearing state of the user of the electronic apparatus 100.

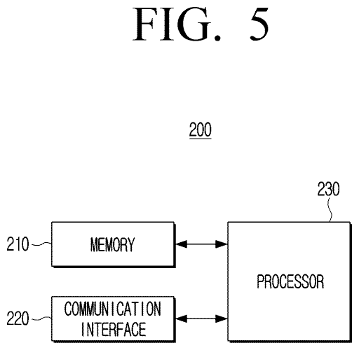

FIG. 5 is a block diagram illustrating a configuration of the user terminal 200, according to an embodiment of the disclosure.

Referring to FIG. 5, the user terminal 200 may include a memory 210, a communication interface 220, and a processor 230. However, embodiments of the present disclosure are not limited thereto, and the user terminal 200 may be implemented with a portion of the configurations omitted.

The memory 210 may refer to hardware that may information such as, but not limited to, data in electric or magnetic form for the processor 230 or the like to access. For example, the memory 210 may be implemented as at least one from among a non-volatile memory, a volatile memory, a flash memory, a hard disk drive (HDD), a solid state drive (SSD), a random access memory (RAM), a read only memory (ROM), or the like.

The memory 210 may store at least one instruction that may be needed in an operation of the user terminal 200 and/or the processor 230. The instruction may refer to a code unit that may instruct (cause) an operation of the user terminal 200 or the processor 230, and may be prepared in a machine language that may be understood (interpreted and/or executed) by a computer.

The memory 210 may store data that may be information formatted in a bit and/or byte unit that may represent a character, a number, an image, or the like. For example, the memory 210 may store one or more instructions for controlling the user terminal 200.

The memory 210 may be accessed by the processor 230, and which may perform reading, writing, modifying, deleting, updating, or the like of the instructions, the instruction set, and/or the data stored in the memory 210.

The communication interface 220 may be configured to perform communication with external devices of various types according to communication methods of various types. For example, the user terminal 200 may perform communication with the electronic apparatus 100 and/or an external device through the communication interface 220.

The communication interface 220 may be and/or may include a Wi-Fi module, a Bluetooth module, an infrared communication module, a wireless communication module, or the like. Each communication module of the communication interface 120 may be implemented in at least one hardware chip form.

The Wi-Fi module and the Bluetooth module may perform communication in a Wi-Fi method and a Bluetooth method, respectively. When using the Wi-Fi module and/or the Bluetooth module, various connection information such as, but not limited to, an SSID and a session key, may be transmitted and received, and after performing communication connection using the same, various information may be transmitted and received. The infrared communication module may perform communication according to an infrared communication technology (e.g., IrDA) of transmitting data wirelessly in short range by using infrared rays present between visible rays and millimeter waves.

The wireless communication module may include at least one communication chip that may perform communication according to various wireless communication standards such as, for example, and without limitation, ZigBee, 3G,3GPP, LTE, LTE-A, 4G, 5G, or the like, in addition to the above-described communication methods.

Alternatively or additionally, the communication interface 220 may include a wired communication interface such as, for example, and without limitation, HDMI, DP, Thunderbolt, USB, RGB, D-SUB, DVI, or the like.

In addition, the communication interface 220 may include at least one from among wired communication modules that may perform communication using a local area network (LAN) module, an Ethernet module, or a pair cable, a coaxial cable or an optical fiber cable, or the like.

The processor 230 may control an overall operation of the user terminal 200. That is, the processor 230 may control the overall operation of the user terminal 200 by being connected with each configuration (element) of the user terminal 200. For example, the processor 230 may control an operation of the user terminal 200 by being connected with configurations such as, but not limited to, the memory 210, the communication interface 220, or the like.

The processor 230 may be implemented as one or more processors. The one or more processors may include one or more from among, but not limited to, a CPU, a GPU, an APU, a MIC, a DSP, an NPU, a hardware accelerator, a machine learning accelerator, or the like. The one or more processors may control one or a random combination from among other elements of the user terminal 200, and may perform an operation associated with communication or data processing. The one or more processors may execute, individually or collectively, one or more programs or instructions stored in the memory 210. For example, the one or more processors may perform, by executing the one or more instructions stored in the memory 210, a method according to an embodiment of the disclosure.

When a method, according to an embodiment of the disclosure, includes a plurality of operations, the plurality of operations may be performed by one processor, or performed by a plurality of processors. For example, when a first operation, a second operation, and a third operation are performed by a method, according to an embodiment, the first operation, the second operation, and the third operation may all be performed by a first processor, or the first operation and the second operation may be performed by the first processor (e.g., generic-purpose processor) and the third operation may be performed by a second processor (e.g., AI dedicated processor). For example, the process for quantizing the neural network model, according to an embodiment of the disclosure, may be performed by the generic-purpose processor, and the process for training or inferring the quantized neural network model may be performed by the AI dedicated processor.

The one or more processors may be implemented as a single core processor that may include one core, or implemented as one or more multicore processors that may include a plurality of cores (e.g., homogeneous multicore or heterogeneous multicore). If the one or more processors are implemented as multicore processors, each of the plurality of cores included in the multicore processors may include a memory inside the processor such as, but not limited to, a cache memory and an on-chip memory, and/or a common cache shared by the plurality of cores may be included in the multicore processors. In addition, each of the plurality of cores (or a portion from among the plurality of cores) included in the multicore processors may independently read and/or perform a program command for implementing a method, according to an embodiment of the disclosure, and/or read and/or perform a program command for implementing a method, according to an embodiment of the disclosure due to a whole (or a portion) of the plurality of cores being interconnected.

When a method, according to an embodiment of the disclosure, includes a plurality of operations, the plurality of operations may be performed by one core from among the plurality of cores or performed by the plurality of cores included in the multicore processors. For example, when a first operation, a second operation, and a third operation are performed by a method, according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In some embodiments of the disclosure, the one or more processors may refer to a system on chip (SoC), the single core processor, or the multicore processors in which the one or more processors and other electronic components are integrated or the core included in the single core processor or the multicore processors, and the core herein may be implemented as the CPU, the GPU, the APU, the MIC, the DSP, the NPU, the hardware accelerator, the machine learning accelerator, or the like. However, embodiments of the present disclosure are not limited thereto. However, for convenience of description, an operation of the user terminal 200 is described below using the expression ‘processor 230.’

The processor 230 may provide, based on the advertising packet being received from the electronic apparatus 100, a response to the advertising packet to the electronic apparatus 100, exchange information on each device during the communication connection period and information for forming the communication channel, and form the communication channel.

The processor 230 may receive the first equalizer information of the electronic apparatus 100 from the electronic apparatus 100 through the communication interface 220 during the communication connection period, and control the communication interface 220 to transmit the first time information to the electronic apparatus 100.

The processor 230 may control, based on the wear state being received from the electronic apparatus 100 through the communication interface 220, the communication interface 220 to transmit the activation signal to the electronic apparatus 100 based on the first equalizer information corresponding to the electronic apparatus 100 and the first time information.

The electronic apparatus 100 may transmit, after performing an operation according to the activation signal, a signal for forming the communication channel to the user terminal, and the processor 230 may control the communication interface 220 to form the communication channel with the electronic apparatus 100 based on the request of the electronic apparatus 100.

Through the operations described above, cross-connection may be prevented. For example, an environment may be assumed in which the electronic apparatus 100, the other electronic apparatus, and the user terminal 200 are present. In addition, it may be assumed that the user terminal 200 is (physically) closer to the electronic apparatus 100 than the other electronic apparatus, and that the user desires for the electronic apparatus 100 to be connected to the user terminal 200.

The processor 230 may receive the advertising packet from the electronic apparatus 100, and receive another advertising packet from the other electronic apparatus.

The processor 230 may receive the first equalizer information of the electronic apparatus 100 from the electronic apparatus 100 through the communication interface 220, control the communication interface 220 to transmit the first time information to the electronic apparatus 100, receive the second equalizer information of the other electronic apparatus from the other electronic apparatus through the communication interface 220, and control the communication interface 220 to transmit the first time information to the other electronic apparatus.

The processor 230 may identify, based on the wear state being received from the electronic apparatus 100 and another wear state being received from the other electronic apparatus through the communication interface 220, the apparatus that provided the information received first (earlier) from among the wear state and the other wear state, and control the communication interface 220 to transmit the activation signal to the electronic apparatus 100 and the other electronic apparatus based on the equalizer information corresponding to the identified apparatus and the time information.

Because the electronic apparatus 100 is closer to the user terminal 200 than the other electronic apparatus, the processor 230 may receive the wear state first than the other wear state. The processor 230 may control the communication interface 220 to transmit the activation signal to the electronic apparatus 100 and the other electronic apparatus based on the first equalizer information corresponding to the electronic apparatus 100 that provided the wear state and the first time information.

The electronic apparatus 100 may output sound based on the activation signal, and form the communication channel with the user terminal 200 because the first equalizer information corresponding to the received sound and first time information are a match with the information exchanged with the user terminal 200.

The another electronic apparatus may output sound based on the activation signal, and may not form the communication channel with the user terminal 200 because the first equalizer information corresponding to the received sound and the first time information are in part different from the second equalizer information and the first time information exchanged with the user terminal 200.

According to various embodiments of the disclosure as described above, cross-connection may be prevented according to an operation according to the equalizer information during the communication connection period and the time information being added.

In addition, by forming the communication channel after the operation according to the equalizer information and the time information, or forming the communication channel after the operation according to the equalizer information and the time information and the operation for re-identifying the wear state, latency may be reduced because the communication channel may be formed without the communication connection period being maintained for a pre-set time.

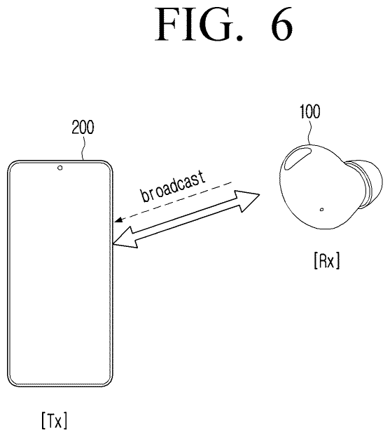

An operation of the electronic apparatus 100 is described below with reference to FIGS. 6 to 15. Although in FIGS. 6 to 15, individual embodiments are described for convenience of description, the individual embodiments of FIGS. 6 to 15 may be implemented in any combined state.

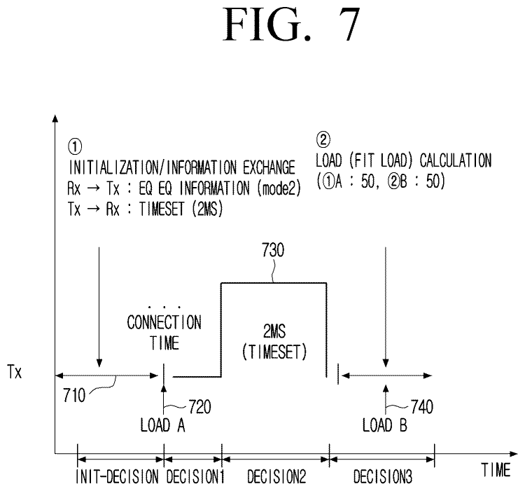

FIGS. 6 and 7 are diagrams illustrating an operation in a communication connection period, according to an embodiment of the disclosure. For example, in FIGS. 6 and 7, one electronic apparatus (receiving (Rx) apparatus) 100 and one user terminal (transmitting (Tx) device) 200 may be assumed.

The electronic apparatus 100 may broadcast the advertising packet when the user command for forming the communication channel with the user terminal 200 is received, as shown in FIG. 6.

The electronic apparatus 100 may exchange, based on the response to the advertising packet of the user terminal 200, the information on each device during the communication connection period and the information for forming the communication channel, and form the communication channel.

For example, the electronic apparatus 100 and the user terminal 200 may perform an initialization/information exchange operation during a period 710 from among the communication connection period, as shown in FIG. 7. Further, the electronic apparatus 100 may transmit the first equalizer information (EQ information (mode2)) of the electronic apparatus 100 to the user terminal 200, and the user terminal 200 may transmit the first time information (Timeset (2 ms)) to the electronic apparatus 100.

The electronic apparatus 100 and the user terminal 200 may store each of the first equalizer information and the first time information in each apparatus and device.

The electronic apparatus 100 may wait for the detection of Load A 720. For example, the electronic apparatus 100 may identify that Load A is detected when the electronic apparatus 100 is worn by the user. The electronic apparatus 100 may transmit, when Load A 720 is detected, detection information to the user terminal 200.

The user terminal 200 may transmit, when the detection information is received, the activation signal to the electronic apparatus 100. The activation signal may be a signal generated based on the first equalizer information corresponding to the electronic apparatus 100 that provided the detection information based on the user terminal 200 receiving the detection information and the first time information. That is, the activation signal may include a command to output sound for a time based on the first time information at a level based on the first equalizer information.

The electronic apparatus 100 may output sound for a time based on the first time information at a level based on the first equalizer information based on the first equalizer information. For example, the electronic apparatus 100 may output sound for 2 ms that may be the first time information at a level based on the first equalizer information as waveform 730.

The electronic apparatus 100 may receive the output sound through the microphone 140, and if the equalizer information and time information corresponding to the received sound is the same as with pre-stored information, Load B 740 may be re-detected. For example, if the electronic apparatus 100 being worn by the user is maintained, Load B 740 may be the same as Load A 720 or may be less than a pre-set difference. That is, the electronic apparatus 100 may transmit, based on Load A 720 and Load B 740 being less than a pre-set difference, a signal requesting forming of the communication channel to the user terminal 200. The user terminal 200 may form the communication channel with the electronic apparatus 100 according to the signal received from the electronic apparatus 100.

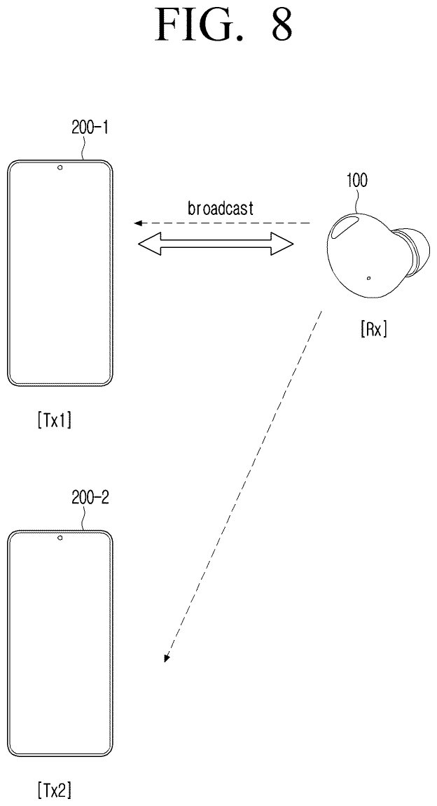

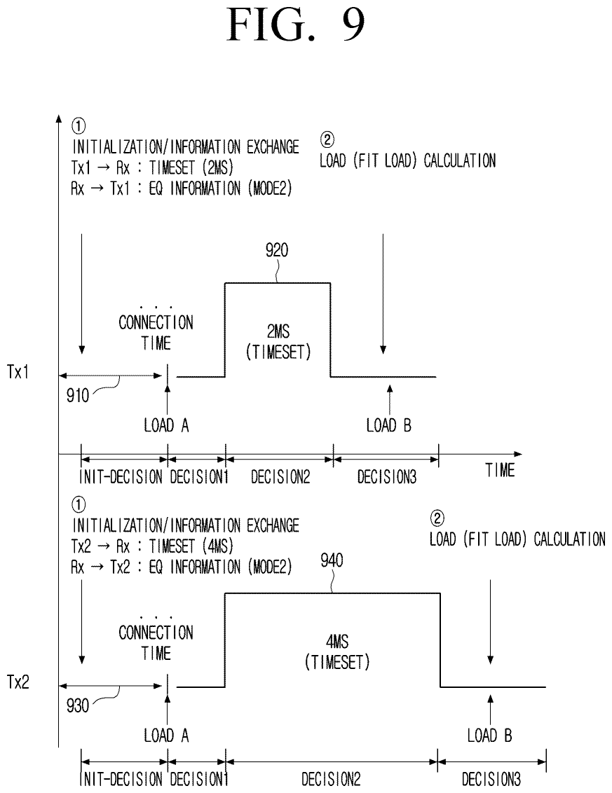

FIGS. 8 and 9 are diagrams illustrating an operation with a plurality of transmitting (Tx) apparatuses, according to an embodiment of the disclosure. For example, in FIGS. 8 and 9, one electronic apparatus (Rx apparatus) 100, a first user terminal (Tx1 device) 200-1, and a second user terminal (Tx2 device) 200-2 may be assumed.

The electronic apparatus 100 may broadcast the advertising packet when a user command for forming a communication channel with the first user terminal 200-1 is received, as shown in FIG. 8.

The electronic apparatus 100 may exchange, based on a response to an advertising packet of the first user terminal 200-1 and a response to an advertising packet of the second user terminal 200-2, the information on each device during the communication connection period and the information for forming the communication channel with the first user terminal 200-1 and the second user terminal 200-2.

For example, the electronic apparatus 100 may perform the initialization/information exchange operation with the first user terminal 200-1 for a period 910 from among the communication connection period, shown in FIG. 9. The electronic apparatus 100 may transmit the first equalizer information (EQ information (mode2)) of the electronic apparatus 100 to the first user terminal 200-1, and the first user terminal 200-1 may transmit the first time information (Timeset (2 ms)) to the electronic apparatus 100.

In addition, the electronic apparatus 100 may perform the initialization/information exchange operation with the second user terminal 200-2 for a period 930 from among the communication connection period, as shown in FIG. 9. The electronic apparatus 100 may transmit the first equalizer information (EQ information (mode2)) of the electronic apparatus 100 to the second user terminal 200-2, and the second user terminal 200-2 may transmit the second time information (Timeset (4 ms)) to the electronic apparatus 100.

The electronic apparatus 100 may map and store the first equalizer information and the first time information with the first user terminal 200-1, and may map and store the first equalizer information and the second time information with the second user terminal 200-2.

The first user terminal 200-1 may map and store the first equalizer information and the first time information with the electronic apparatus 100, and the second user terminal 200-2 may map and store the first equalizer information and the second time information with the electronic apparatus 100.

The electronic apparatus 100 may transmit, based on Load A being detected, the detection information to the first user terminal 200-1 and the second user terminal 200-2.

The first user terminal 200-1 may transmit, based on the detection information being received, a first activation signal to the electronic apparatus 100, and the second user terminal 200-2 may transmit, based on the detection information being received, a second activation signal to the electronic apparatus 100. The first activation signal may be a signal generated based on the first equalizer information corresponding to the electronic apparatus 100 that provided the detection information based on the first user terminal 200-1 receiving the detection information and the first time information, and the second activation signal may be a signal generated based on the first equalizer information corresponding to the electronic apparatus 100 that provided the detection information based on the second user terminal 200-2 receiving the detection information and the second time information.

The electronic apparatus 100 may receive the first equalizer information and the second equalizer information. However, because the first user terminal 200-1 may be closer to the electronic apparatus 100 than the second user terminal 200-2, the electronic apparatus 100 may receive the first equalizer information first than the second equalizer information.

The electronic apparatus 100 may output sound for a time based on the first time information at a level based on the first equalizer information based on the first equalizer information received first (earlier). For example, the electronic apparatus 100 may output sound for 2 ms that may be the first time information at a level based on the first equalizer information as waveform 920.

The electronic apparatus 100 may receive the output sound through the microphone 140, identify the first user terminal 200-1 as a target device for forming the communication channel based on the equalizer information corresponding to the received sound and the time information, and re-detect Load B 740. The electronic apparatus 100 may transmit, based on Load A 720 and Load B 740 being less than the pre-set difference, a signal requesting the forming of the communication channel to the first user terminal 200-1. The first user terminal 200-1 may form the communication channel with the electronic apparatus 100 according to the signal received from the electronic apparatus 100.

As described above, the electronic apparatus 100 may output sound based on the first equalizer information received first for convenience of description. However, embodiments of the present disclosure are not limited thereto. For example, the electronic apparatus 100 may output a first sound based on the first equalizer information received first, and output a second sound based on the first equalizer information received thereafter. As another example, the electronic apparatus 100 may output the second sound for 4 ms that may be the second time information at a level based on the first equalizer information such as waveform 940 after outputting the first sound for 2 ms that may be the first time information at a level based on the first equalizer information as waveform 920. However, because the first sound is output first than the second sound, the electronic apparatus 100 may identify the first user terminal 200-1 corresponding to the first sound as the target for forming the communication channel. That is, the electronic apparatus 100 may form the communication channel with the first user terminal 200-1 that may be closer in distance with the electronic apparatus 100.

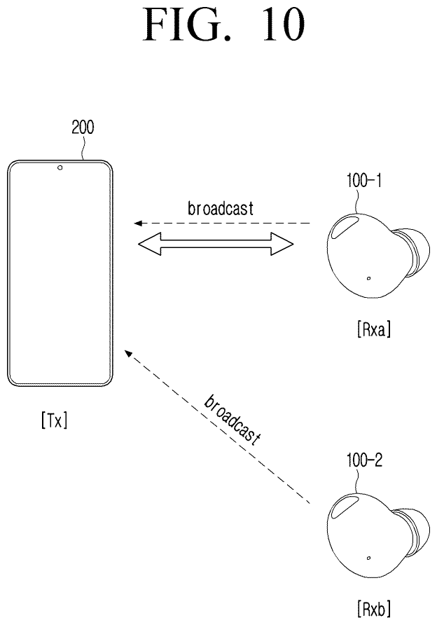

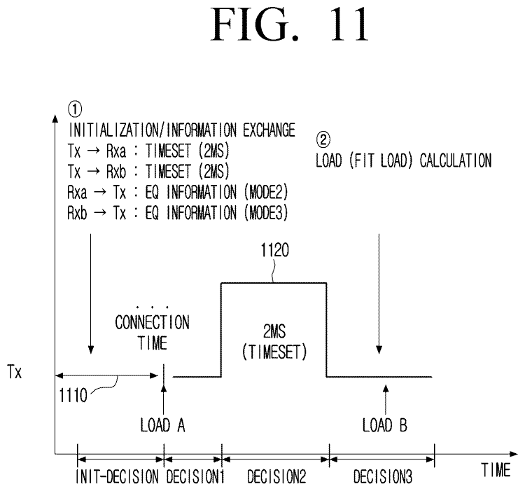

FIGS. 10 and 11 are diagrams illustrating an operation with a plurality of receiving (Rx) apparatuses, according to an embodiment of the disclosure. For example, in FIGS. 10 and 11, a first electronic apparatus (Rxa apparatus) 100-1, a second electronic apparatus (Rxb apparatus) 100-2, and the user terminal (Tx device) 200 may be assumed. Each of the first electronic apparatus 100-1 and the second electronic apparatus

100-2 may broadcast the advertising packet when the user command for forming the communication channel with the user terminal 200 is received as shown in FIG. 10.

Each of the first electronic apparatus 100-1 and the second electronic apparatus 100-2 may exchange the information on each device during the communication connection period and the information for forming the communication channel based on the response to the advertising packet of the user terminal 200.

For example, each of the first electronic apparatus 100-1 and the second electronic apparatus 100-2 may perform the initialization/information exchange operation with the user terminal 200 for a period 1110 from among the communication connection period, as shown in FIG. 11. The first electronic apparatus 100-1 may transmit the first equalizer information (EQ information (mode2)) of the first electronic apparatus 100-1 to the user terminal 200, the second electronic apparatus 100-2 may transmit the second equalizer information (EQ information (mode3)) of the second electronic apparatus 100-2 to the user terminal 200, and the user terminal 200 may transmit the first time information (Timeset (2 ms)) to the first electronic apparatus 100-1 and the second electronic apparatus 100-2.

The first electronic apparatus 100-1 may map and store the first equalizer information and the first time information with the user terminal 200, and the second electronic apparatus 100-2 may map and store the second equalizer information and the first time information with the user terminal 200.

The user terminal 200 may map and store the first equalizer information and the first time information with the first electronic apparatus 100-1, and may map and store the second equalizer information and the first time information with the second electronic apparatus 100-2.

The first electronic apparatus 100-1 and the second electronic apparatus 100-2 may transmit, when Load A is detected, each of first detection information and second detection information to the user terminal 200. For example, the first electronic apparatus 100-1 may be worn by a first user, the second electronic apparatus 100-2 may be worn by a second user, and may be worn for nearly the same time.

The user terminal 200 may receive the first detection information and the second detection information. However, because the first electronic apparatus 100-1 may be closer with the user terminal 200 than the second electronic apparatus 100-2, the user terminal 200 may receive the first detection information first than the second detection information.

The user terminal 200 may transmit the activation signal to the first electronic apparatus 100-1 and the second electronic apparatus 100-2 based on the first equalizer information corresponding to the first electronic apparatus 100-1 that provided the first detection information received first and the first time information.

Each of the first electronic apparatus 100-1 and the second electronic apparatus 100-2 may output sound for a time based on the first time information at a level based on the first equalizer information based on the activation signal. For example, each of the first electronic apparatus 100-1 and the second electronic apparatus 100-2 may output sound for 2 ms that may be the first time information at a level based on the first equalizer information as waveform 1120.

The first electronic apparatus 100-1 may identify, based on the output sound being received, the user terminal 200 as the target device for forming the communication channel based on the equalizer information and time information corresponding to the received sound, and re-detect Load B. The first electronic apparatus 100-1 may transmit, based on Load A and Load B being less than the pre-set difference, the signal requesting the forming of the communication channel to the user terminal 200. The user terminal 200 may form the communication channel with the first electronic apparatus 100-1 according to the signal received from the first electronic apparatus 100-1.

The second electronic apparatus 100-2 may receive the output sound. However, because the equalizer information and time information corresponding to the received sound are different from the pre-stored information, an additional operation may not be performed.

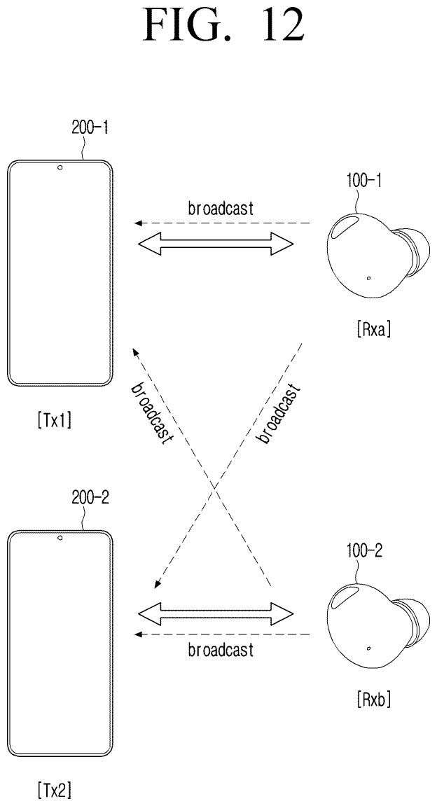

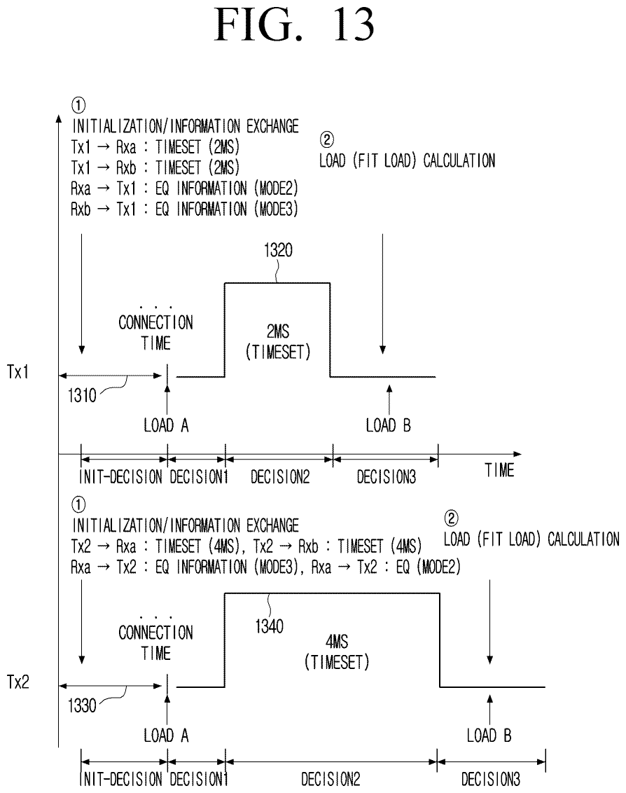

FIGS. 12 and 13 are diagrams illustrating an operation with a plurality of transmitting (Tx) apparatuses and a plurality of receiving (Rx) apparatuses, according to an embodiment of the disclosure. For example, in FIGS. 12 and 13, the first electronic apparatus (Rxa apparatus) 100-1, the second electronic apparatus (Rxb apparatus) 100-2, the first user terminal (Tx1 device) 200-1, and the second user terminal (Tx2 device) 200-2 may be assumed.

The first electronic apparatus 100-1 may broadcast the advertising packet when a user command for forming the communication channel with the first user terminal 200-1 is received, as shown in FIG. 12, and the second electronic apparatus 100-2 may broadcast the advertising packet when a user command for forming the communication channel with the second user terminal 200-2 is received.

Operations thereafter may be similar with that described in FIGS. 8 to 11. Consequently, repeated descriptions of the operations described above with reference to FIGS. 8 to 11 may be omitted for the sake of brevity.

For example, the first electronic apparatus 100-1, the second electronic apparatus 100-2, the first user terminal 200-1, and the second user terminal 200-2 may exchange the information on each device during the communication connection period and the information for forming the communication channel, as shown in FIG. 13. In addition, each device may exchange the equalizer information and the time information for a time period 1310 and a time period 1330 in FIG. 13.

The first user terminal 200-1 may receive the first detection information from the first electronic apparatus 100-1, and receive the second detection information from the second electronic apparatus 100-2. However, because the first user terminal 200-1 may be closer with the first electronic apparatus 100-1 than the second electronic apparatus 100-2, the first detection information may be received first (earlier) than the second detection information. Accordingly, the first user terminal 200-1 may transmit the first equalizer information to the electronic apparatus 100-1 and the second electronic apparatus 100-2 based on the first detection information.

The second user terminal 200-2 may receive the first detection information from the first electronic apparatus 100-1, and receive the second detection information from the second electronic apparatus 100-2. However, because the second user terminal 200-2 may be closer with the second electronic apparatus 100-2 than the first electronic apparatus 100-1, the second detection information may be received first (earlier) than the first detection information. Accordingly, the second user terminal 200-2 may transmit the second equalizer information to the first electronic apparatus 100-1 and the second electronic apparatus 100-2 based on the second detection information.

The first electronic apparatus 100-1 may receive the first equalizer information from the first user terminal 200-1, and receive the second equalizer information from the second user terminal 200-2. However, because the first electronic apparatus 100-1 may be closer with the first user terminal 200-1 than the second user terminal 200-2, the first equalizer information may be received first (earlier) than the second equalizer information. Accordingly, the first electronic apparatus 100-1 may output sound such as waveform 1320 based on the first equalizer information, and consequently form the communication channel with the first user terminal 200-1.

The second electronic apparatus 100-2 may receive the first equalizer information from the first user terminal 200-1, and receive the second equalizer information from the second user terminal 200-2. However, because the second electronic apparatus 100-2 may be closer with the second user terminal 200-2 than the first user terminal 200-1, the second equalizer information may be received first (earlier) than the first equalizer information. Accordingly, the second electronic apparatus 100-2 may output sound such as waveform 1340 based on the second equalizer information, and consequently form the communication channel with the second user terminal 200-2.

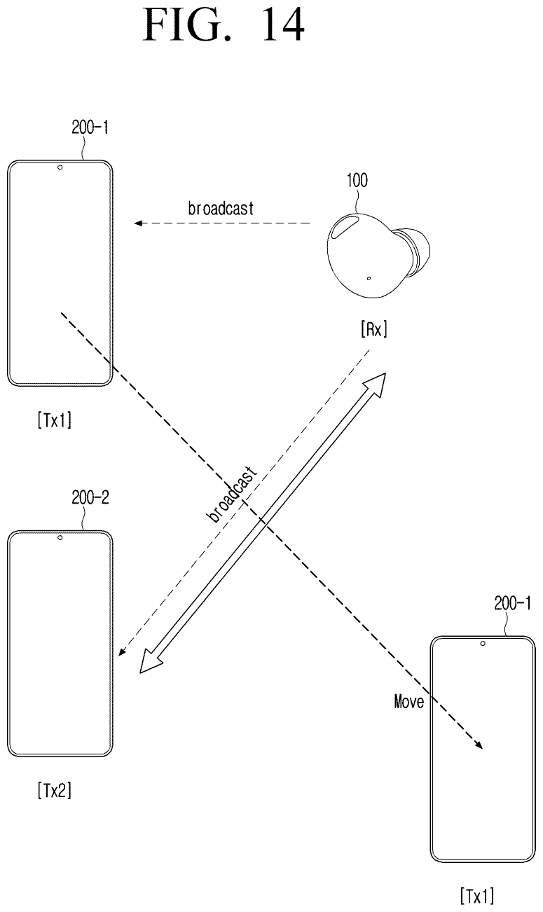

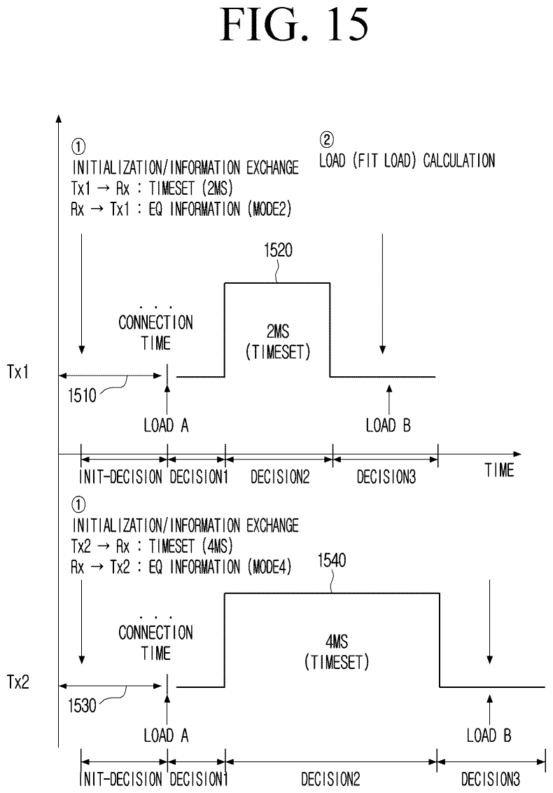

FIGS. 14 and 15 are diagrams illustrating an operation when a transmitting apparatus from among a plurality of transmitting (Tx) apparatuses moves, according to an embodiment of the disclosure. For example, in FIGS. 14 and 15, one electronic apparatus (Rx apparatus) 100, the first user terminal (Tx1 device) 200-1, and the second user terminal (Tx2 device) 200-2 may be assumed.

The electronic apparatus 100 may broadcast the advertising packet when the user command for forming the communication channel with the first user terminal 200-1 is received as shown in FIG. 14.

Operations thereafter may be similar with that described in FIGS. 8 and 9. Consequently, repeated descriptions of the operations described above with reference to FIGS. 8 and 9 may be omitted for the sake of brevity.

For example, the electronic apparatus 100, the first user terminal 200-1, and the second user terminal 200-2 may exchange the information on each device during the communication connection period and the information for forming the communication channel, as shown in FIG. 15. In addition, each device may exchange the equalizer information and the time information for a time period 1510 and a time period 1530 in FIG. 15.

After a position of the first user terminal 200-1 is moved, each of the first user terminal 200-1 and the second user terminal 200-2 may receive the detection information from the electronic apparatus 100. In this case, the first user terminal 200-1 may transmit the first equalizer information to the electronic apparatus 100 based on the detection information, and the second user terminal 200-2 may transmit the second equalizer information to the electronic apparatus 100 based on the detection information.

The electronic apparatus 100 may receive the first equalizer information from the first user terminal 200-1, and receive the second equalizer information from the second user terminal 200-2. However, because the electronic apparatus 100 may be closer with the second user terminal 200-2 than the first user terminal 200-1 according to the position of the first user terminal 200-1 being moved, the second equalizer information may be received first (earlier) than the first equalizer information. Accordingly, the electronic apparatus 100 may output sound such as waveform 1540 based on the second equalizer information, and consequently form the communication channel with the second user terminal 200-2. The electronic apparatus 100 may output sound such as waveform 1520 based on the first equalizer information received thereafter, but because the second user terminal 200-2 has been first identified as the target for forming the communication channel, no operation whatsoever may be performed with respect to the sound such as waveform 1520.

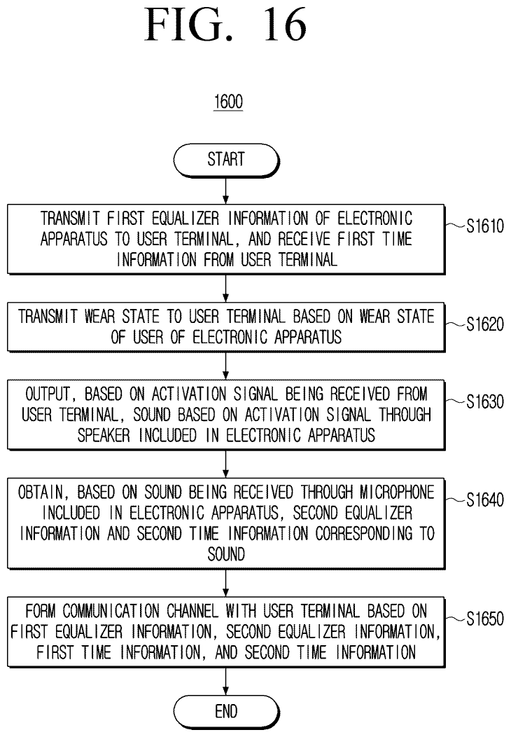

FIG. 16 is a flowchart illustrating a control method of an electronic apparatus, according to an embodiment of the disclosure.

Referring to FIG. 16, the control method 1600 may include transmitting first equalizer information of the electronic apparatus to a user terminal, and first time information may be received from the user terminal (operation S1610). A wear state may be transmitted to the user terminal based on a wear state of a user of the electronic apparatus (operation S1620). When an activation signal is received from the user terminal, sound may be output through a speaker included in the electronic apparatus based on the activation signal (operation S1630). When the sound is received through a microphone included in the electronic apparatus, second equalizer information and second time information corresponding to the sound may be obtained (operation S1640). A communication channel with the user terminal may be formed based on the first equalizer information, the second equalizer information, the first time information, and the second time information (operation S1650).

In addition, the forming (operation S1650) may include forming, based on the first equalizer information and the second equalizer information being the same, and the first time information and the second time information being the same, the communication channel with the user terminal.

The forming (operation S1650) may include re-identifying, based on the first equalizer information and the second equalizer information being the same, and the first time information and the second time information being the same, the wear state of the user of the electronic apparatus, and forming the communication channel with the user terminal based on the re-identified wear state.

In addition, the forming (operation S1650) may include forming, based on a difference of the re-identified wear state with the wear state being less than the pre-set difference, the communication channel with the user terminal.

Further, the transmitting a wear state (operation S1620) may include transmitting, based on the electronic apparatus being identified as worn by the user, the wear state to the user terminal.

In addition, the transmitting a wear state (operation S1620) may include obtaining the wear state through the sensor included in the electronic apparatus, or obtaining the wear state based on transfer functions of first signal information corresponding to the sound being output through the speaker and second signal information corresponding to the sound received through the microphone.

The activation signal may include a command to output sound for a time based on second time information at a level based on the second equalizer information.

In addition, the receiving (operation S1610) may include transmitting the first equalizer information of the electronic apparatus to another user terminal, and receiving third time information from the other user terminal, and the transmitting (operation S1620) may include transmitting the wear state to the other user terminal, and the outputting (operation S1630) may include controlling, based on the activation signal being received from the user terminal and another activation signal being received from the other user terminal, the speaker to output sound based on the signal received first (earlier) from among the activation signal and the other activation signal.

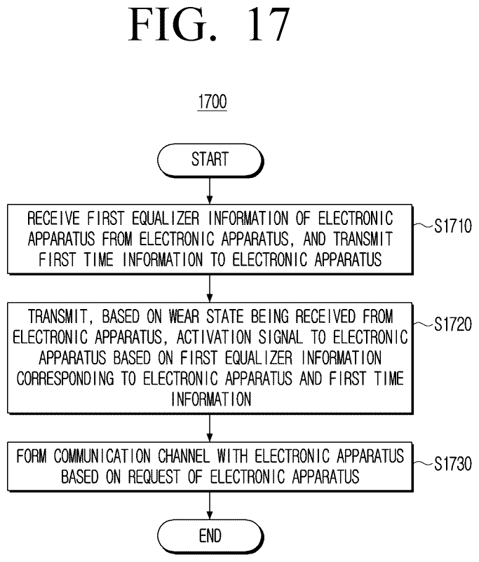

FIG. 17 is a flowchart illustrating a control method of a user terminal, according to an embodiment of the disclosure.

Referring to FIG. 17, the control method 1700 may include receiving first equalizer information of an electronic apparatus from the electronic apparatus, and first time information may be transmitted to the electronic apparatus (operation S1710). When a wear state is received from the electronic apparatus, an activation signal may be transmitted to the electronic apparatus based on the first equalizer information corresponding to the electronic apparatus and the first time information (operation S1720). A communication channel may be formed with the electronic apparatus based on a request of the electronic apparatus (operation S1730).

In addition, the transmitting first time information (operation S1710) may include receiving second equalizer information of another electronic apparatus from the other electronic apparatus, and transmitting first time information to the other electronic apparatus, and the transmitting an activation signal to the electronic apparatus (operation S1720) may include identifying, based on a wear state being received from the electronic apparatus and another wear state being received from another electronic apparatus, a device that provided the information received first from among the wear state and the other wear state, and transmitting the activation signal to the electronic apparatus and the other electronic apparatus based on the equalizer information corresponding to the identified device and the time information.

According to the various embodiments of the disclosure as described above, cross-connection may be prevented according to an operation based on the equalizer information during the communication connection period and the time information being added.

In addition, by forming the communication channel after the operation according to the equalizer information and the time information, or forming the communication channel after the operation according to the equalizer information and the time information and the operation for re-identifying the wear state, latency may be reduced because the communication channel may be formed without the communication connection period being maintained for a pre-set time.

According to an embodiment of the disclosure, the various embodiments described above may be implemented with software including instructions stored in a machine-readable storage media (e.g., computer). The machine may call a stored instruction from a storage medium, and as a device operable according to the called instruction, may include an electronic apparatus (e.g., electronic apparatus (A)) according to the above-mentioned embodiments. Based on a command being executed by the processor, the processor may directly or using other elements under the control of the processor perform a function relevant to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, according to an embodiment of the disclosure, the various embodiments described above may be implemented in a recordable medium that may be readable by a computer or a device similar to the computer using software, hardware, or the combination of software and hardware. In some cases, embodiments described herein may be implemented by the processor itself. According to a software implementation, embodiments such as the procedures and functions described herein may be implemented with separate software modules. The respective software modules may perform one or more functions and operations described herein.

According to an embodiment, computer instructions for performing processing operations in the devices, according to the various embodiments described above, may be stored in a non-transitory computer-readable medium. The computer instructions stored in this non-transitory computer-readable medium may cause a specific device to perform a processing operation in a device, according to the above-described various embodiments, when executed by a processor of the specific device. The non-transitory computer-readable medium may refer to a medium that stores data semi-permanently rather than a medium that stores data for a very short time, such as a register, a cache, a memory, or the like, and is readable by a device. Specific examples of the non-transitory computer-readable medium may include, for example, and without limitation, a compact disc (CD), a digital versatile disc (DVD), a hard disc, a Blu-ray disc, a USB, a memory card, a ROM, or the like.

In addition, respective elements (e.g., a module or a program), according to the various embodiments described above, may be configured as a single entity or a plurality of entities, and a portion of sub-elements from among the above-mentioned relevant sub-elements may be omitted or other sub-elements may be further included in the various embodiments. Alternatively or additionally, a portion of the elements (e.g., modules or programs) may be integrated into one entity to perform the same or similar functions performed by each of the relevant elements prior to integration. Operations performed by a module, a program, or other element, in accordance with the various embodiments, may be executed sequentially, in parallel, repetitively, or in a heuristically manner, or at least a portion of the operations may be executed in a different order, or omitted, or a different operation may be added.

While the present disclosure has been illustrated and described with reference to example embodiments thereof, it is to be understood that the various example embodiments are intended to be illustrative, not limiting. It is to be understood by those skilled in the art that various changes in form and details may be made therein without departing from the true spirit and full scope of the disclosure, including the appended claims and their equivalents.

What is claimed is:

1. An electronic apparatus comprising:
a communication interface;
a speaker;
a microphone;
one or more processors comprising processing circuitry; and
memory storing instructions,
wherein the instructions, when executed by the one or more processors individually or collectively, cause the electronic apparatus to:
transmit, to a first user terminal through the communication interface, first equalizer information of the electronic apparatus;
receive, from the first user terminal through the communication interface, first time information;
transmit, to the first user terminal through the communication interface, a first wear state of a user of the electronic apparatus, based on the first wear state;
based on a first activation signal being received from the first user terminal through the communication interface, output a first sound via the speaker;
based on a second sound being received through the microphone, obtain second equalizer information and second time information corresponding to the second sound; and
establish, through the communication interface, a communication channel with the first user terminal based on the first equalizer information, the second equalizer information, the first time information, and the second time information.

2. The electronic apparatus of claim 1, wherein the instructions, when executed by the one or more processors individually or collectively, further cause the electronic apparatus to:
based on the first equalizer information and the second equalizer information being the same, and the first time information and the second time information being the same, establish the communication channel with the first user terminal through the communication interface.

3. The electronic apparatus of claim 2, wherein the instructions, when executed by the one or more processors individually or collectively, further cause the electronic apparatus to:
based on the first equalizer information and the second equalizer information being the same, and the first time information and the second time information being the same, identify a second wear state of the user of the electronic apparatus; and
establish, through the communication interface, the communication channel with the first user terminal based on the second wear state.

4. The electronic apparatus of claim 3, wherein the instructions, when executed by the one or more processors individually or collectively, further cause the electronic apparatus to:
based on a difference between the second wear state and the first wear state being less than a predetermined difference, establish the communication channel with the first user terminal through the communication interface.

5. The electronic apparatus of claim 1, wherein the instructions, when executed by the one or more processors individually or collectively, further cause the electronic apparatus to:
based on the electronic apparatus being identified as worn by the user, transmit the first wear state to the first user terminal through the communication interface.

6. The electronic apparatus of claim 1, further comprising:
a sensor,
wherein the instructions, when executed by the one or more processors individually or collectively, further cause the electronic apparatus to:
obtain the first wear state using the sensor.

7. The electronic apparatus of claim 1, wherein the instructions, when executed by the one or more processors individually or collectively, further cause the electronic apparatus to:
obtain the first wear state based on transfer functions of first signal information corresponding to the first sound and second signal information corresponding to the second sound.

8. The electronic apparatus of claim 1, wherein the first activation signal comprises a command to output a third sound for a time duration based on the second time information at a level based on the second equalizer information.

9. The electronic apparatus of claim 1, wherein the instructions, when executed by the one or more processors individually or collectively, further cause the electronic apparatus to:
transmit, to a second user terminal through the communication interface, the first equalizer information;
receive, from the second user terminal through the communication interface, third time information;
transmit, to the second user terminal through the communication interface, the first wear state; and
based on an earlier received signal from among the first activation signal being received from the first user terminal and a second activation signal being received from the second user terminal through the communication interface, output a third sound via the speaker.

10. A user terminal comprising:
a communication interface;
one or more processors comprising processing circuitry; and
memory storing instructions,
wherein the instructions, when executed by the one or more processors individually or collectively, cause the user terminal to:
receive, from a first electronic apparatus through the communication interface, first equalizer information of the first electronic apparatus;
transmit, to the first electronic apparatus through the communication interface, first time information;
based on a wear state being received from the first electronic apparatus through the communication interface, transmit a first activation signal to the first electronic apparatus through the communication interface based on the first equalizer information corresponding to the first electronic apparatus and the first time information; and
establish, through the communication interface, a communication channel with the first electronic apparatus based on a request of the first electronic apparatus.

11. The user terminal of claim 10, wherein the instructions, when executed by the one or more processors individually or collectively, further cause the user terminal to:
receive, from a second electronic apparatus through the communication interface, second equalizer information of the second electronic apparatus;
transmit, to the second electronic apparatus through the communication interface, the first time information;
identify a device corresponding to an earlier received wear state from among a first wear state received from the first electronic apparatus and a second wear state received from the second electronic apparatus through the communication interface; and
transmit a second activation signal to the first electronic apparatus and the second electronic apparatus, based on equalizer information corresponding to the device and time information.

12. A control method of an electronic apparatus, the control method comprising:
transmitting, to a first user terminal, first equalizer information of the electronic apparatus;
receiving, from the first user terminal, first time information;
transmitting, to the first user terminal, a first wear state of a user of the electronic apparatus;
based on a first activation signal being received from the first user terminal, outputting a first sound via a speaker of the electronic apparatus;
based on a second sound being received through a microphone of the electronic apparatus, obtaining second equalizer information corresponding to the second sound and second time information; and
establishing a communication channel with the first user terminal based on the first equalizer information, the second equalizer information, the first time information, and the second time information.

13. The control method of claim 12, wherein the establishing of the communication channel comprises:
based on the first equalizer information and the second equalizer information being the same, and the first time information and the second time information being the same, establishing the communication channel with the first user terminal.

14. The control method of claim 13, wherein the establishing of the communication channel comprises:
based on the first equalizer information and the second equalizer information being the same, and the first time information and the second time information being the same, identifying a second wear state of the user of the electronic apparatus; and
establishing the communication channel with the first user terminal based on the second wear state.

15. The control method of claim 14, wherein the establishing of the communication channel comprises:
based on a difference between the second wear state and the first wear state being less than a predetermined difference, establishing the communication channel with the first user terminal.

16. The control method of claim 12, wherein the transmitting of the first wear state comprises:
based on the electronic apparatus being identified as worn by the user, transmitting the first wear state to the first user terminal.

17. The control method of claim 12, further comprising:
obtaining, using a sensor of the electronic apparatus, the first wear state.

18. The control method of claim 12, further comprising:
obtaining the first wear state based on transfer functions of first signal information corresponding to the first sound and second signal information corresponding to the second sound.

19. The control method of claim 12, wherein the first activation signal comprises a command to output a third sound for a time duration based on the second time information at a level based on the second equalizer information.

20. The control method of claim 12, further comprising:
transmitting, to a second user terminal, the first equalizer information;
receiving, from the second user terminal, third time information;
transmitting, to the second user terminal, the first wear state; and
outputting, via the speaker, a third sound based on an earlier received signal from among the first activation signal being received from the first user terminal and a second activation signal being received from the second user terminal.
